(19) United States
(12) Patent Application Publication
(10) Pub. No.: US 2003/0080896 A1
(43) Pub. Date: May 1, 2003

(54) Portable communication device antenna

(76) Inventor: Chidambaram Shankar, Gurnee, IL (US)

Correspondence Address: MOTOROLA INC, 600 NORTH US HIGHWAY 45, LIBERTYVILLE, IL, 60048-5343, US

(21) Appl. No.: 10/045,440

(22) Filed: Oct. 29, 2001

(51) Int. Cl. G01S 3/00; H04B 7/00

(52) U.S. Cl. 342/350; 343/850

(57) ABSTRACT

The present invention relates to an antenna that increases efficiency through the addition of a series antenna element within a portable communication device such as a radiotelephone. The series antenna element includes a conductive material disposed on a dielectric. The series antenna element makes the antenna electrically longer, which increases the efficiency of a retractable antenna in both positions or a fixed “stubby” antenna. Efficiency is improved by more radio frequency power being deposited on the series antenna element causing the series antenna element to radiate radio frequencies outside of the portable communication device, which reduces the current on the circuit board. There are fewer dropped calls, improved reception and transmission of radio frequencies, and increased signal strength.

### FIELD OF THE INVENTION

This invention relates to portable communication devices and more particularly to portable communication device antennas and combinations thereof.

### BACKGROUND OF THE INVENTION

Wireless communication devices include portable communication devices, portable cellular phones, two-way devices, and personal communicators. Portable communication devices traditionally communicate with a remote base station to provide wireless communication to a user. Portable communication devices have circuitry to receive or transmit radio frequency signals via antennas. The antenna transmits and receives radio frequencies (RF) to enable wireless communication.

Portable communication devices operate in cellular systems that reside in different frequency bands. For example, time division multiplex access (TDMA) systems operate in bands from 890 Megahertz (MHz) to 960 MHZ and 1710 MHz to 1880 MHz. Personal Communication System (PCS) operates in a band from 1850 MHz to 1990 MHz and analog systems operate in bands from 824 MHz to 894 MHz. Today, most portable communication device devices operate in two bands, for example 800/1900 MHz and 900/1800 MHz. A portable communication device having dual-band capability allows a user to access one or more cellular systems that may be present in a given region.

A portable communication device that operates in two or more frequency bands requires an antenna system that is capable of receiving and transmitting signals in these distinct frequency bands. The antenna is a critical element of a communication device. Its performance determines the overall efficiency of the device. Antenna efficiency determines the amount of dropped calls, the quality of reception and transmission of radio frequencies (RF), and signal strength in each band.

Conventional antennas include external antennas and Planar Inverted F-Antennas (PIFA). External antennas are located outside of the portable communication device housing. They can be fixed or retracted from a first position to a second position. The user is required to extend the antenna before operating the portable communication device since the antenna typically performs better when in the extended position.

A helix antenna may have several resonance frequencies as function of the wire length, pitch angle, and the number of helical turns. The resonance frequencies can be adjusted by using proper techniques to obtain a single-band or multi-band operation. These techniques may include varying the helix wire dimensions and/or adding other components.

PIFAs are internal antennas that eliminate the need for external antennas and are either single band or dual band. PIFA's include an electrically conductive ground plane parallel to a planar electrically conductive radiating element, and a ground contact interconnecting them.

The antenna function is required to have enough sensitivity in all intended use positions to transmit and receive radio frequencies with very little loss. The antenna must be small enough to add to the portable communication device without increasing its size. Importantly, it must provide consistent performance in all use positions, i.e., when the phone is clipped to the belt, when the user is dialing, or when the user is speaking into the phone.

### BRIEF DESCRIPTION OF THE DRAWINGS

The features of the present invention which are believed to be novel are set forth with particularity in the appended claims. The invention, together with further objects and advantages thereof, may best be understood by making reference to the following description, taken in conjunction with the accompanying drawings, in the several figures of which like reference numbers identify like elements, and wherein:

FIG. 1 is a block diagram of a wireless communication device.

FIG. 2 is a series antenna element according to the present invention.

FIG. 3 is a top plan view of a circuit board showing a series antenna element.

### DETAILED DESCRIPTION OF THE INVENTION

One embodiment of the present invention relates to an antenna that increases efficiency through the addition of a series antenna element within a portable communication device such as a radiotelephone. The series antenna element includes a conductive material disposed on a dielectric. The series antenna element makes the antenna electrically longer, which increases the efficiency of a retractable antenna in both positions or a fixed “stubby” antenna. Efficiency is improved by more radio frequency power being deposited on the series antenna element causing the series antenna element to radiate radio frequencies outside of the portable communication device, which reduces the current on the circuit board. There are fewer dropped calls, improved reception and transmission of radio frequencies, and increased signal strength.

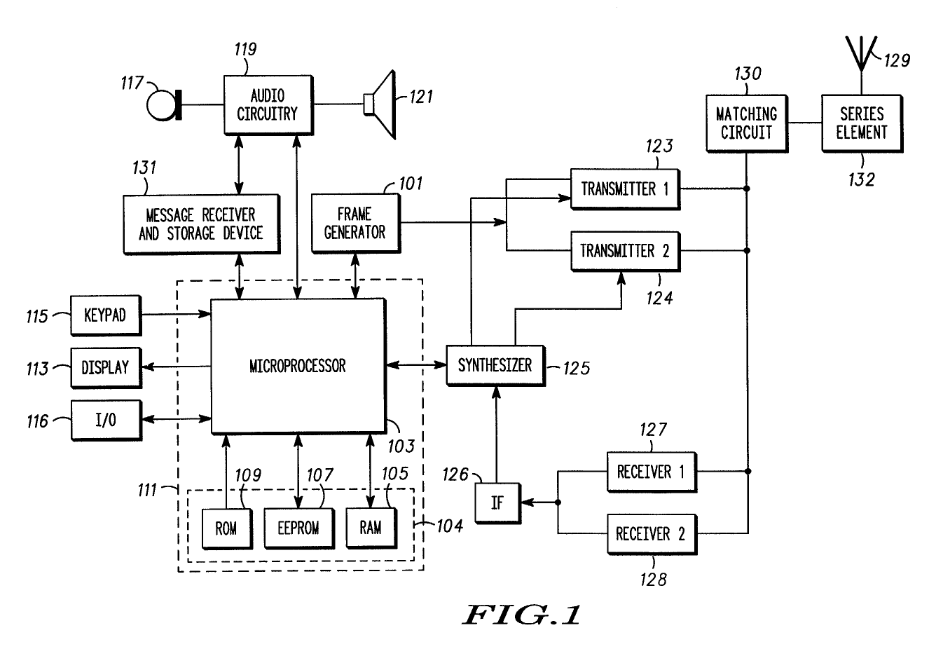

FIG. 1 is a block diagram of a wireless communication device, such as a dual band cellular portable communication device, incorporating the present invention. In the exemplary embodiment, a frame generator ASIC 101, such as a CMOS ASIC available from Motorola, Inc. and a microprocessor 103, such as a 68HC11 microprocessor also available from Motorola, Inc., combine to generate the necessary communication protocol for operating in a cellular system. Microprocessor 103 uses memory 104 comprising RAM 105, EEPROM 107, and ROM 109, preferably consolidated in one package 111, to execute the steps necessary to generate the protocol and to perform other functions for the communication unit, such as writing to a display 113, accepting information from a keypad 115, controlling a frequency synthesizer 125, or performing steps necessary to amplify a signal according to the method of the present invention. Frame generator ASIC 101 processes audio transformed by audio circuitry 119 from a microphone 117 and to a speaker 121.

A transceiver processes the radio frequency signals. In particular, transmitters 123 and 124 transmit through antenna 129 using carrier frequencies produced by a frequency synthesizer 125. Information received by the antenna 129 of the portable communication device enters receivers 127 and 128. The information transmitted or received is sent through a matching network 130 and a series antenna element 132. Receivers 127 and 128 demodulate the symbols comprising the message frame using the carrier frequencies from frequency synthesizer 125. The transmitters and receivers are collectively called a transceiver. The communication device may optionally include a message receiver and storage device 131 including digital signal processing means. The message receiver and storage device could be, for example, a digital answering machine or a paging receiver. The antennas of the present invention may be used in other communication devices.

For illustrative purposes, the present invention is described in conjunction with an external retractable antenna. It is understood that the present invention can be implemented with internal antennas, for example PIFA, as well as external fixed antennas.

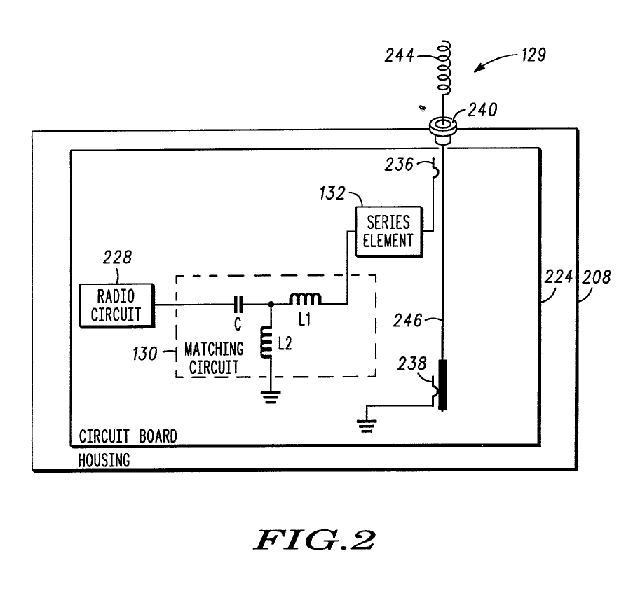

Turning now to FIG. 2, in one such embodiment configured according to the present invention, a portable communication device comprises a housing 208; a circuit board 224, an antenna assembly 129, a radio circuit 228, an antenna matching circuit 130, a series antenna element 132, a antenna feedpoint 236, and a ground terminal 238 coupled with a ground. Circuit board 224 is disposed inside housing 208, and radio circuit 228, antenna matching circuit 130, series antenna element 132, antenna feedpoint 236, and ground terminal 238 can be disposed on circuit board 224. The functions and features of the portable communication device are determined by the electrical components that are mounted on circuit board 224. Typically, circuit boards are made from a fire retardant laminate material, for example, glass laminate, or epoxy laminate. Glass laminates are widely used for printed circuit board fabrication because of their ability to meet a wide variety of processing conditions. Thermally stable copper-clad epoxy-glass laminates offer high mechanical strength.

Antenna assembly 129 includes bushing 240 and first antenna portion 244, for example a helical coil, and second antenna portion 246, for example a rod. First antenna portion 244 is carried by second antenna portion 246 and can be electrically coupled, for example by direct electrical contact, to second antenna portion 246. Bushing 240 can be affixed to housing 208, and antenna assembly 129 is moveable within bushing 240 from a retracted position to an extended position.

In the extended position, first antenna portion 244 is located outside of housing 208 and second antenna portion 246 is substantially located outside of housing 208. Further, a first coupling location of the antenna, e.g., the lower end of second antenna portion 246, is electrically coupled with antenna feedpoint 236. In the retracted position, first antenna portion 244 is located substantially outside of housing 208, and second antenna portion 246 is located inside housing 208. Further, antenna feedpoint 236 is electrically coupled, for example by capacitive coupling, with a second coupling location of the antenna, e.g., the lower end of first antenna portion 244, and ground terminal 238 is electrically coupled, e.g., in direct electrical contact, with a first coupling location. Capacitive and direct coupling can be implemented for the first coupling location and the second coupling location, although each coupling location could be coupled by some other means.

Radio circuit 228 can be, e.g., a duplexer, a transmitter, a receiver, a modulator, a demodulator, or traces connecting the components of radio circuit 228, or some combination of these components and traces.

Antenna matching circuit 130 is coupled between series antenna element 132 and radio circuit 228. Antenna matching circuit 130 can be, e.g., a T-connected circuit with a capacitor C in one arm, an inductor L₁ in the other arm, and a ground-terminated inductor L₂ in the leg. Antenna matching circuit 130 matches the impedance at the output of radio circuit 228 to the impedance at the input of antenna assembly 129. Antenna matching circuit 130 ensures adequate radio frequency power is delivered to the internal series antenna element 132 and external antenna 129, or first antenna portion 244.

Series antenna element 132 is coupled between antenna feedpoint 236 and antenna matching circuit 130. Series antenna element 132 includes a conductor printed on a dielectric. The conductor is any substance or medium that conducts an electric charge, for example, copper. The dielectric is a substance or medium that does not conduct an electric charge, for example, air or a circuit board which is made of retardant laminate material. Series antenna element 132 is located within the portable communication device and can be placed on circuit board 224, suspended within the portable communication device, or on the housing of the portable communication device. If series antenna element 132 is suspended or located on the housing of the portable communication device, pogo pins or stamped metal can connect the input of series antenna element 132 to antenna matching circuit 130 and the output of series antenna element 132 to antenna feedpoint 236.

Those skilled in the art will recognize that various modifications and variations, in addition to those already described, can be made in the portable communication device of the present invention and in construction of this portable communication device without departing from the scope or spirit of this invention. As examples, an area where antenna feedpoint 236 couples with antenna 129 in the retracted position can define the demarcation between first antenna portion 244 and second antenna portion 246. Accordingly, first antenna portion 244 can be any part of rod 246, or all of rod 246 and a part of first antenna portion 244. Furthermore, first antenna portion 244 and second antenna portion 246 can be radiating elements of different shapes. Also, instead of second antenna portion 246 being a quarter wavelength, it can be of a different wavelength, terminated with an impedance, or surrounded by a conductive tube that is grounded. Also, antenna feedpoint 236 and bushing 240 can be the same component, and antenna feedpoint 236, or ground terminal 238 can be disposed on housing 208 or a component inside housing 208. Series antenna 132 may be used alone or in combination with another antenna.

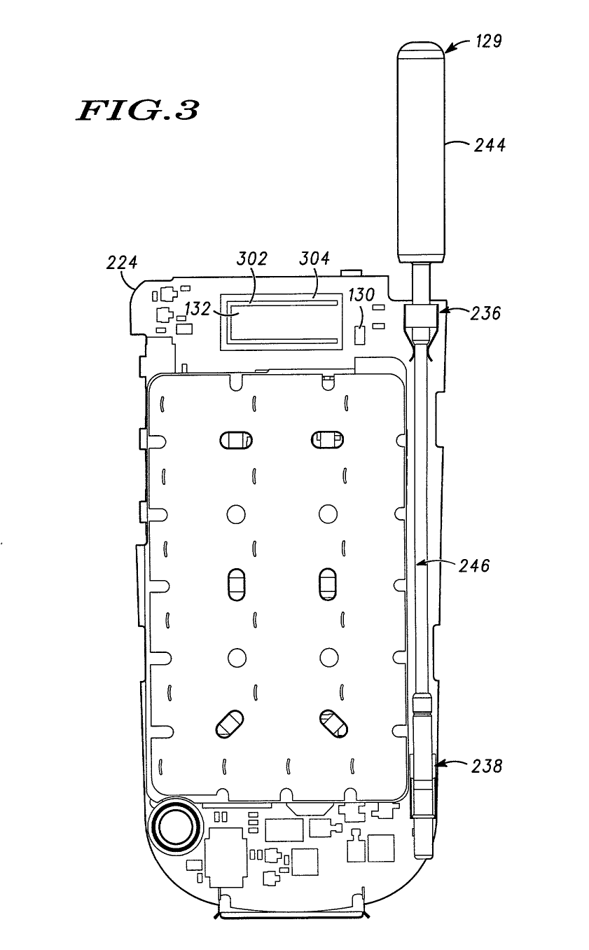

FIG. 3 is a top plan view of a circuit board showing a series antenna element. Radio circuit generates radio frequency radio frequency power during operation. Radio circuit delivers the radio frequency power, or radio frequencies (RF), it generates into the input of antenna matching circuit 130. Antenna matching circuits are typically embedded into the circuit board and they function to transform output impedance of the radio circuit to input impendence of the antenna assembly 129. Impedance is the measure of the total opposition to the flow of electric current. Impedance is made up of two components, ohmic resistance and reactance, and usually represented in complex notation as Z=R+iX, where R is the ohmic resistance and X is the reactance. Antenna matching circuit 130 achieves maximum radio frequency radio frequency power transformation by transforming output impedance of the radio circuit to input impendence of antenna assembly 129. Maximum radio frequency radio frequency power transformation creates an efficient system.

Radio frequency power typically travels from antenna matching circuit 130 to antenna feedpoint 236, but the present invention increases efficiency with the addition of series antenna element 132. The radio frequency power travels from antenna matching circuit 130 to series antenna element 132 and then to antenna feedpoint 236.

Radio frequency power travels from antenna matching circuit 130 to the input of series element 132. Series element 132 is a conductor 302 and a dielectric 304, for example copper printed onto a circuit board. Series element 132 radiates radio frequency power and extends the length of antenna 129 both physically and electrically. Series antenna element 132 makes the antenna electrically longer, which improves the efficiency by more radio frequency power being deposited on series antenna element 132. Series antenna element 132 radiates radio frequency power outside of the portable communication device, which reduces the current on circuit board 244. There are fewer dropped calls, improved reception and transmission of radio frequencies, and increased signal strength.

The present invention does not require a ground plane, or a conducting surface. An antenna typically needs a ground plane, a surface that actually works as a part of the antenna system to transmit radio frequencies, even through there is no electrical connection between it and the antenna. Ground planes shield radio circuitry from radio frequency power. In the present invention, the series element radiates and shields radio frequency power from the circuitry. A ground plane could be used in the present invention, although it is not required.

The radio frequencies travel from the output of series antenna element 132 to antenna feedpoint 236. Antenna feedpoint 236 is located on circuit board 224 and is typically a copper pad for attaching external antenna 129. Antenna feedpoint 236 receives radio frequency power from the output of internal series antenna 132. Eternal antenna 244 transmits radio frequencies for wireless communication. Antenna assembly 129, which comprises of series element 132 and external antenna element 244, radiates radio frequency power outside the phone in order to complete a cellular call.

The invention has been described and illustrated in the above description and drawings, it is understood that this description is by way of example and those skilled in the art can make numerous changes and modifications without departing from the true spirit and scope of the invention. Although the present invention finds particular application in portable communication devices, the invention could be applies to any wireless communication device, including radiotelephones, pages, electronic, organizers, or computers.

We claim:

1. An antenna system comprising:
an antenna matching circuit;
a first antenna;
a series antenna with a first end and a second end, the first end coupled to the first antenna and the second end coupled to the antenna matching circuit.

2. The antenna system of claim 1, the series antenna comprises a conductor on a dielectric.

3. The antenna system of claim 1, the series antenna comprises a conductor on a dielectric, devoid of a ground plane.

4. The antenna system of claim 1, the series antenna disposed on the circuit board.

5. The antenna system of claim 2, the conductor is copper.

6. The antenna system of claim 2, the dielectric is a circuit board.

7. The antenna system of claim 2, the dielectric is air.

8. A mobile communication handset comprising:
an antenna matching circuit;
a radio circuit coupled to the antenna matching circuit;
a series antenna having a conductor portion disposed on a dielectric, the conductive portion coupled to the antenna matching circuit.

9. The handset of claim 8, a second antenna having a feedpoint coupled to an output of the series antenna, the antenna matching circuit coupled to an input of the series antenna.

10. The handset of claim 8, the series antenna comprises a conductor on a dielectric, devoid of a ground plane.

11. The handset of claim 8, the series antenna disposed on the circuit board.

12. The handset of claim 8, the conductor is copper.

13. The handset of claim 8, the dielectric is a circuit board.

14. The handset of claim 8, the dielectric is air.

15. A method in a communication handset, comprising:
increasing efficiency by increasing the length of a first antenna with a series antenna disposed between the first antenna and an antenna matching circuit;
reducing current on a circuit board by depositing radio frequency power on the series antenna.
